(19) United States
(12) Patent Application Publication
(10) Pub. No.: US 2026/0140600 A1
(43) Pub. Date: May 21, 2026

(54) METHOD FOR COMPOSING STRUCTURE AND ITEMS FOR CONSISTENT MENUS IN USER INTERFACES

(71) Applicant: Danfoss Power Electronics A/S, Grästen (DK)

(72) Inventors: Klaus Lüking, Nordborg (DK); Nina Wetcke, Sønderborg (DK)

(21) Appl. No.: 19/389,560

(22) Filed: Nov. 14, 2025

(30) Foreign Application Priority Data
Nov. 18, 2024 (DE) 102024133641.2

(51) Int. Cl. G06F 3/0482; G06F 3/04845; G06F 3/04886; H02M 7/42

(52) U.S. Cl. CPC G06F 3/0482; G06F 3/04845; G06F 3/04886; H02M 7/42

(57) ABSTRACT

A user interface includes a display (302) for presenting a menu structure, an input interface (303) for enabling a user to navigate within the menu structure and to feed input data, a memory system (304) storing first menu data (306) defining the menu structure, and a data processing system (305) that controls the display to present the menu structure in accordance with the first menu data. The memory system stores second menu data (307) defining which of menu items defined by the first menu data correspond to functionality of an electric device or system, and the display is controlled to present, as active and selectable menu items, only those menu items which correspond to the functionality. As the menu structure defined by the first menu data can be used in different electric devices and systems, the menu structures of these electric devices and systems can be similar with consistent appearances.

### CROSS-REFERENCE TO RELATED APPLICATION

This application claims foreign priority benefits under 35 U.S.C. § 119 from German Patent Application No. 102024133641.2 filed Nov. 18, 2024, the content of which is hereby incorporated by reference in its entirety.

### TECHNICAL FIELD

The invention relates generally to configuring, monitoring, and/or trouble shooting electric devices and systems such as motor drives, power converters, and electrolyzers, etc. More particularly, the invention relates to a method for implementing a user interface and to a user interface for managing an electric device or system. Furthermore, the invention relates to a computer program for implementing a user interface by loading the computer program into a programmable device or system.

### BACKGROUND

Electric devices for implementing electric systems, such as electric drives, encompass a diverse range of products designed for various application types and sizes. For example, electric devices for implementing electric drives may comprise active front end “AFE” converters which are between an alternating voltage “AC” power grid and a direct voltage “DC” intermediate circuit, inverters “INU” which are between the DC intermediate circuit and electric motors and/or other AC devices, protection and monitoring devices such as protection relays, and other possible elements of an electric drive.

Despite the wide range of products designed for various application types, there is often a situation in which same users take care of commissioning, performing start-ups, handling maintenance and troubleshooting, and possible other tasks related to different electric devices such as e.g. motor drives, power converters, electrolyzers, and protection and monitoring devices. As a corollary, the users must learn to navigate within menu structures of all these electric devices to be able to carry out the above-mentioned tasks. This can be both time and cost consuming for the users when using the electric devices for implementing electric systems such as e.g. electric drives. Furthermore, it can be time and cost consuming for a vendor of the electric devices to maintain a product portfolio with different menu structures.

Exemplifying user interfaces for configuring electric devices are described for example in publications EP1883009, US20080215978, U.S. Pat. No. 6,181,331, and EP1604450. The known user interfaces do not however address the above-described challenge related to the diverse range of products designed for various application types and sizes.

### SUMMARY

The following presents a simplified summary to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments.

In accordance with the invention, there is provided a new method for implementing a user interface suitable for managing an electric device or system such as a motor drive, a power converter, an electrolyzer, a protection and/or monitoring device or system, etc. The managing carried out with the user interface may comprise e.g. configuring, monitoring, and/or troubleshooting of the electric device or system.

The method according to the invention comprises:
maintaining, in a memory system, first menu data defining a menu structure,
configuring a data processing system to control a display to present the menu structure defined by the first menu data to a user,
configuring an input interface to receive navigation input actions given by the user to navigate within the menu structure and to receive input data for the electric device or system, and
configuring the data processing system to submit the input data received from the input interface to the electric device or system.

Furthermore, the method according to the invention comprises:
maintaining, in the memory system, second menu data defining which of menu items defined by the first menu data correspond to functionality of the electric device or system under consideration, and
configuring the data processing system to control the display to present, as active and selectable menu items, only those of the menu items which correspond to the functionality of the electric device or system.

The menu structure defined by the first menu data may comprise for example menu items such as “rotational speed”, “reactive power supplied to an AC grid”, “DC current”, etc. The above-mentioned second menu data can be specific to a type of the electric device or system. In an exemplifying case, where the electric system is an alternating current “AC” motor drive, menu items “AC current supplied by an AC grid”, “AC voltage of an AC motor”, “DC voltage of an intermediate circuit, “AC current of the AC motor”, and “rotational speed of the AC motor” correspond to the functionality of the AC motor drive whereas a menu item “DC current of a DC load” does not correspond to the functionality of the AC motor drive. Thus, the second menu data related to the AC motor drive expresses that the menu items “AC current supplied by an AC grid”, “AC voltage of the AC motor”, “DC volage of an intermediate circuit”, “AC current of the AC motor”, and “rotational speed of the AC motor” correspond to the functionality of the AC motor drive. Correspondingly, in another exemplifying case where an electric device is an inverter for driving an AC electric motor, the second menu data expresses that the menu item “AC current supplied to by an AC grid” does not correspond to the functionality of the inverter that can be between an AC electric motor and a DC intermediate circuit or another DC power supply. An electric system, comprising either an Active Front End “AFE” or a passive front end, e.g. a diode rectifier, and an inverter for driving an AC motor or a DC-DC converter for driving a DC motor, handles conversion between AC and DC in various configurations: from grid AC to intermediate circuit DC to motor AC, or from grid AC to intermediate circuit DC to motor DC. The first menu data may define a menu structure that includes items such as “rotational speed”, “reactive power supplied to an AC grid”, “DC current”, and so on. The second menu data, on the other hand, is specific to the type of electric system. For example, in the case of a motor drive having an AFE converter, the menu items “reactive power supplied to an AC grid” and “DC current” correspond to the functions of the AFE converter, while the menu item “rotational speed” does not, as the AFE converter operates between an AC power grid and a DC intermediate circuit. Therefore, the second menu data specific to the AFE converter reflects that the relevant menu items include “reactive power supplied to an AC grid”, DC voltage, and “DC current”. In contrast, if the electric device is an inverter designed to drive an AC electric motor, the second menu data indicates that “reactive power supplied to an AC grid” is not relevant to the inverter, which operates between a DC intermediate circuit or another DC power supply and the AC motor.

As the menu structure defined by the first menu data can be a generic menu structure that can be used in different electric devices and systems, the menu structures of these electric devices and systems can be similar with consistent appearances so that icons, menu items, and their naming can be similar across these electric devices and systems. This provides the following advantages:
Enhanced brand recognition by users of the electric devices and systems since different electric devices and systems have similar menu structures with consistent appearances, I [symbol]
Improved learnability because of the similarity and the consistent appearances of the menu structures of different electric devices and systems,
Saving costs due to reduced training times because of the improved learnability,
Improved usability, i.e. faster use and less mistakes, because of the improved learnability,
easier portfolio maintenance because of the similarity and the consistent appearances of the menu structures of different electric devices and systems, and
minimizing faults caused by e.g. entering configuration data into irrelevant input fields or wrong configuration data into correct input fields.

In an exemplifying and non-limiting embodiment, the display is controlled to show each menu item which does not correspond to the functionality of the electric device or system with a different graphical outlook e.g. a different color than the active and selectable menu items. An advantage of this embodiment is that menu structures of different electric devices and systems do not differ from each other, but the disadvantage is that non-active menu items are shown in the menu structures. In another exemplifying and non-limiting embodiment, the display is controlled to present the menu structure without each menu item which does not correspond to the functionality of an electric device or system under consideration. An advantage of this embodiment is that non-active menu items are not shown in the menu structures, but the disadvantage is that the menu structures of different electric devices and systems differ from each other—but however the menu structures have substantially similar appearances.

Various embodiments of the invention can be computer implemented invention “CII” embodiments. Therefore, in accordance with the invention, there is also provided a new computer program for programming an electric device or system that has a programmable central processing unit “CPU” and/or another programmable data processing system to be capable of running a user interface suitable for managing the electric device or system. The computer program can be, for example, in a form of a signal so that the computer program can be downloaded from a server via a data transfer network into a programmable electric device or system, e.g. a CPU of a power electronic converter. For another example, the computer program can be in the form of a non-volatile computer readable medium, e.g. an electrically erasable read-only memory “EEPROM” or a universal serial bus “USB” memory, encoded with the computer program and connectable to a programmable electric device or system, e.g. a CPU of a power electronic converter.

The computer program according to the invention comprises computer executable instructions for controlling a programmable data processing system to:
retrieve, from a memory system, first menu data defining a menu structure, c [symbol]
control a display to present the menu structure defined by the first menu data to a user,
receive, from an input interface, navigation input actions given by the user to navigate within the menu structure and input data for the electric device or system, and
submit the input data received from the input interface e to the electric device or system.

Furthermore, the computer program according to the invention comprises computer executable instructions for controlling the programmable data processing system to:
retrieve, from the memory system, second menu data defining which of menu items defined by the first menu data correspond to functionality of the electric device, and
control the display to present, as active and selectable menu items, only those of the menu items which correspond to the functionality of the electric device.

In accordance with the invention, there is also provided a new computer program product. The computer program product comprises a non-volatile computer readable medium, e.g. an EEPROM” or a USB memory, encoded with a computer program according to the invention.

In accordance with the invention, there is also provided a new user interface suitable for managing an electric device or system such as a motor drive, a power converter, an electrolyzer, a protection and/or monitoring device or system, etc. The managing carried out with the user interface may comprise e.g. configuring, monitoring, and/or troubleshooting of the electric device or system. The user interface can be for example a part of the electric device or system to be managed, or the user interface can be a part of an external device, e.g. a laptop or a smartphone, connectable to the electric device or system to be managed, or a part of the user interface can be a part of the electric device or system to be managed and another part of the of the user interface can be a part of an external device. Thus, the invention is not limited to any specific ways to implement the user interface.

The user interface according to the invention comprises:
a display configured to present a menu structure to a user,
an input interface configured to enable the user to navigate within the menu structure and to provide input data for the electric device or system,
a memory system storing first menu data defining the menu structure, and
a data processing system communicatively connected to the display, to the input interface, and to the memory system.

The data processing system is configured to control the display to present the menu structure in accordance with the first menu data and with navigation input actions received from the input interface, and to submit the input data received from the input interface to the electric device or system. Furthermore, the memory system is configured to store second menu data defining which of menu items defined by the first menu data correspond to functionality of the electric device or system under consideration. The data processing system is configured to control the display to present, as active and selectable menu items, only those of the menu items which correspond to the functionality of the electric device or system.

In accordance with the invention, there is also provided a new power electronic converter that can be for example a frequency converter, an active front end “AFE” alternating voltage—direct voltage “AC-DC” converter, or a direct voltage—alternating voltage DC-AC inverter “INU”. The power electronic converter comprises:
a power electronic main circuit configured to convert one or more input voltages to one or more output voltages,
control equipment configured to control the power electronic main circuit, and
a user interface according to the invention.

The user interface can be implemented at least partly with same hardware as the above-mentioned control equipment, or the user interface can be implemented with separate hardware with respect to the control equipment.

Exemplifying and non-limiting embodiments are described in accompanied dependent claims.

Exemplifying and non-limiting embodiments both as to constructions and to methods of operation, together with additional objects and advantages thereof, will be best understood from the following description of specific exemplifying and non-limiting embodiments when read in conjunction with the accompanying drawings.

The verbs “to comprise” and “to include” are used in this document as open limitations that neither exclude nor require the existence of un-recited features.

The features recited in dependent claims are mutually freely combinable unless otherwise explicitly stated.

Furthermore, it is to be understood that the use of “a” or “an”, i.e. a singular form, throughout this document does not exclude a plurality.

### BRIEF DESCRIPTION OF THE DRAWINGS

Exemplifying and non-limiting embodiments and their advantages are explained in greater detail below in the sense of examples and with reference to the accompanying drawings, in which:

FIG. 1 shows a flowchart of a method according to an exemplifying and non-limiting embodiment for implementing a user interface suitable for managing an electric device or system.

FIG. 2a illustrates details of an exemplifying menu structure accomplished with a method according to an exemplifying and non-limiting embodiment,

FIG. 2b illustrates details of an exemplifying menu structure accomplished with a method according to an exemplifying and non-limiting embodiment, and

FIG. 3 illustrates a user interface according to an exemplifying and non-limiting embodiment for managing an electric device.

### DETAILED DESCRIPTION

The specific examples provided in the description below should not be construed as limiting the scope and/or the applicability of the invention. Lists and groups of examples provided in the description are not exhaustive unless otherwise explicitly stated.

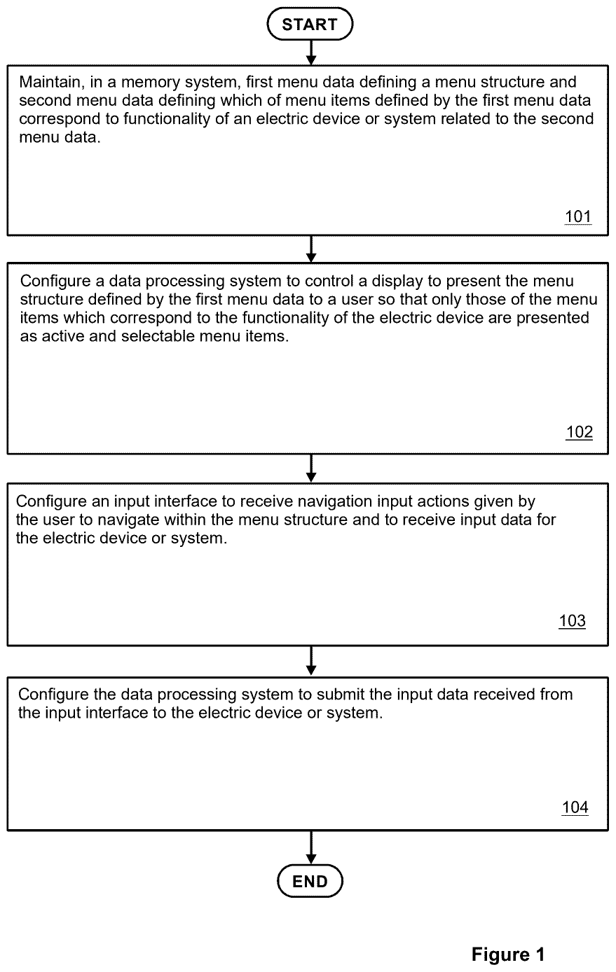

FIG. 1 shows a flowchart of a method according to an exemplifying and non-limiting embodiment for implementing a user interface suitable for managing an electric device or system such as a motor drive, a power converter, an electrolyzer, a protection and/or monitoring device or system, etc. The managing carried out with the user interface may comprise e.g. configuring, monitoring, and/or troubleshooting of the electric device or system. The method comprises the following actions:
action 101: maintaining, in a memory system, first menu data defining a menu structure and second menu data defining which of menu items defined by the first menu data correspond to functionality of the electric device or system under consideration,
action 102: configuring a data processing system to control a display to present the menu structure defined by the first menu data to a user so that only those of the menu items which correspond to the functionality of the electric device or system are presented as active and selectable menu items,
action 103: configuring an input interface to receive navigation input actions given by the user to navigate within the menu structure and to receive input data such as e.g. configuration data, monitoring instructions, and/or troubleshooting instructions for the electric device or system, and
action 104: configuring the data processing system to submit the input data received from the input interface to the electric device or system.

A method according to an exemplifying and non-limiting embodiment comprises configuring the data processing system to control the display to show each menu item which does not correspond to the functionality of the electric device or system with a different graphical outlook than the active and selectable menu items.

A method according to an exemplifying and non-limiting embodiment comprises configuring the data processing system to control the display to present the menu structure without each menu item which does not correspond to the functionality of the electric device or system.

In a method according to an exemplifying and non-limiting embodiment, the input interface comprises a keyboard having arrow and selection buttons for enabling the user to move in the menu structure and alphanumeric buttons enabling the user to feed an item of the input data when an input field for feeding the item of the input data has been activated.

In a method according to an exemplifying and non-limiting embodiment, the display comprises a touch screen acting as the input interface, and the method comprises configuring the data processing system to control the display to present virtual arrow and selection buttons enabling the user to move in the menu structure and virtual alphanumeric buttons enabling the user to feed an item of the input data when an input field for feeding the item of the input data has been activated.

In a method according to an exemplifying and non-limiting embodiment, the menu structure comprises a hierarchy of menus defined by the first menu data.

In a method according to an exemplifying and non-limiting embodiment, the menu items comprise: statuses of one or more elements of the electric device or system, logs and reports related to the one or more elements, events related to the one or more elements, set up and service data related to the one or more elements, data about the electric device or system, and/or other suitable information related to the electric device or system.

The above-mentioned data processing system can be for example a central processing unit “CPU” or another processing unit of the electric device or system to be managed, e.g. a CPU of a frequency converter of an electric motor drive. Alternatively, the data processing system can be an external device, e.g. a processor of a laptop or a smartphone, communicatively connected to the CPU or to the other processing unit of the electric device or system to be managed. Correspondingly, the display and/or the input interface can be an element or elements of the electric device or system to be configured e.g. a frequency converter or, alternatively, the display and/or the input interface can belong to an external device, e.g. a laptop or a smartphone, communicatively connected to the CPU or to the other processing unit of the electric device or system to be managed.

A computer program according to an exemplifying and non-limiting embodiment for implementing a user interface suitable for managing an electric device or system comprises computer executable instructions for controlling a programmable data processing system to carry out actions related to a method according to any of the above-described exemplifying and non-limiting embodiments.

A computer program according to an exemplifying and non-limiting embodiment comprises software modules for implementing a user interface suitable for managing an electric device or system. The software modules comprise computer executable instructions for controlling a programmable data processing system to:
retrieve, from a memory system, first menu data defining a menu structure and second menu data defining which of menu items defined by the first menu data correspond to functionality of the electric device or system under consideration,
control a display to present the menu structure defined by the first menu data to a user so that only those of the menu items which correspond to the functionality of the electric device or system are presented as active and selectable menu items,
receive, from an input interface, navigation input actions given by the user to navigate within the menu structure and receive input data such as e.g. configuration data, monitoring instructions, and/or troubleshooting instructions for the electric device or system, and
submit the input data received from the input interface to the electric device or system.

The software modules can be for example subroutines or functions implemented with programming tools suitable for the programmable data processing system.

A computer program product according to an exemplifying and non-limiting embodiment comprises a computer readable medium, e.g. an EEPROM” or a USB memory, encoded with a computer program according to an exemplifying embodiment of the invention.

A signal according to an exemplifying and non-limiting embodiment is encoded to carry information defining a computer program according to an exemplifying embodiment of the invention.

A non-volatile computer readable medium, e.g. an EEPROM” or a USB memory, according to an exemplifying and non-limiting embodiment is encoded with a computer program according to an exemplifying embodiment of the invention.

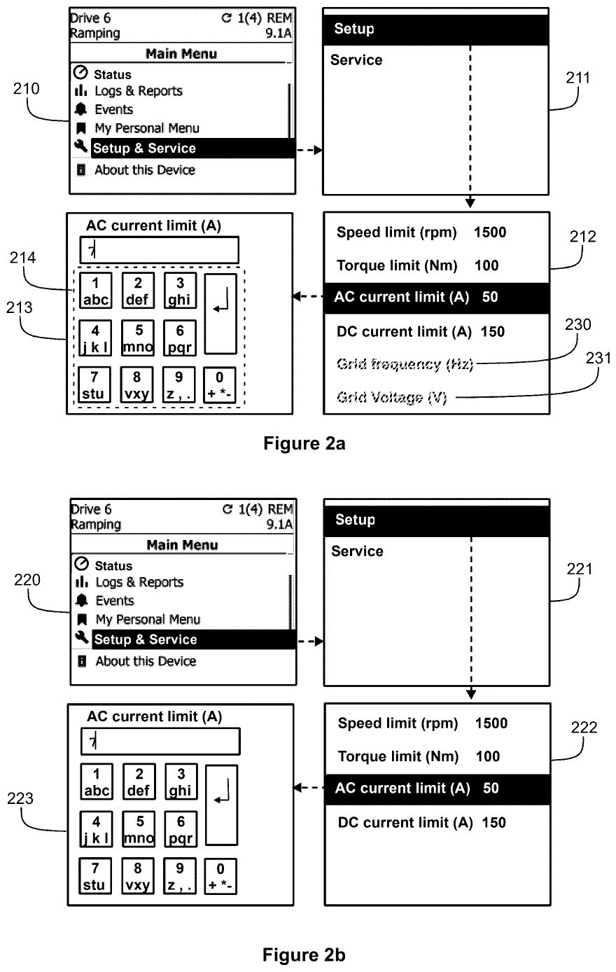

FIG. 2a illustrates details of an exemplifying menu structure accomplished with a method according to an exemplifying and non-limiting embodiment. In this exemplifying embodiment, the display comprises a touch screen that acts as the input interface and the data processing system is configured to control the display to present virtual alphanumeric buttons 214 to enable the user to feed input data. In a first menu view 210, a main menu is shown. In the exemplifying situation shown in FIG. 2a, the menu item “Setup & Service” has been selected from the first menu view 210 leading to a second menu view 211. In the exemplifying situation shown in FIG. 2a, the menu item “Setup” has been selected from the second menu view 211 leading to a third menu view 212. In the exemplifying situation shown in FIG. 2a, the menu item “AC current limit” has been selected from the third menu view 212 leading to a view 213 comprising the above-mentioned virtual alphanumeric buttons 214 which enable a user to set a value of the AC current limit.

In the exemplifying and non-limiting embodiment illustrated in FIG. 2a, the data processing system is configured to control the display to show each menu item which does not correspond to the functionality of an electric device or system, e.g. a motor drive, a motor-inverter, or an AFE converter, etc., with a different graphical outlook than the active and selectable menu items. In FIG. 2a, the menu items “Grid frequency” and “Grid voltage” which do not correspond to the functionality of the electric device or system are denoted with references 230 and 231. As shown in FIG. 2a, these menu items 230 and 231 are shown in the third menu view 212 with a different graphical outlook than the other menu items.

FIG. 2b illustrates details of an exemplifying menu structure accomplished with a method according to an exemplifying and non-limiting embodiment. Menu views 220, 221, and 223 are same as the menu views 210, 211, and 213 shown in FIG. 2a, respectively. In the exemplifying embodiment illustrated in FIG. 2b, the data processing system is configured to control the display to present the menu structure without each menu item which does not correspond to the functionality of the electric device. Thus, the menu view 222 shown in FIG. 2b differs from the menu view 212 shown in FIG. 2a in that the menu view 222 does not contain the menu items 230 “Grid frequency” and 231 “Grid voltage”.

An advantage of the exemplifying and non-limiting embodiment illustrated in FIG. 2a is that menu structures of different electric devices do not differ from each other, but the disadvantage is that non-active menu items, such as the menu items 230 and 231, are shown in the menu structures. An advantage of the exemplifying and non-limiting embodiment illustrated in FIG. 2b is that non-active menu items are not shown in the menu structures, but the disadvantage is that the menu structures of different electric devices differ from each other—although the menu structures have substantially similar appearances.

In the exemplifying and non-limiting embodiments illustrated in FIGS. 2a and 2b, the menu structure comprises a hierarchy of menus defined by the first menu data. The second menu data defines which ones of the menu items in these menus as shown as active and selectable menu items. In the exemplifying cases illustrated in FIGS. 2a and 2b, the second menu data defines that the menu items 230 “Grid frequency” and 231 “Grid voltage” are not presented as active and selectable menu items.

As shown in FIGS. 2a and 2b, the menu items may comprise for example statuses of one or more elements of the electric device or system, logs and reports related to the one or more elements, events related to the one or more elements, set up and service data related to the one or more elements, data about the electric device or system, and/or other suitable information related to the electric device or system.

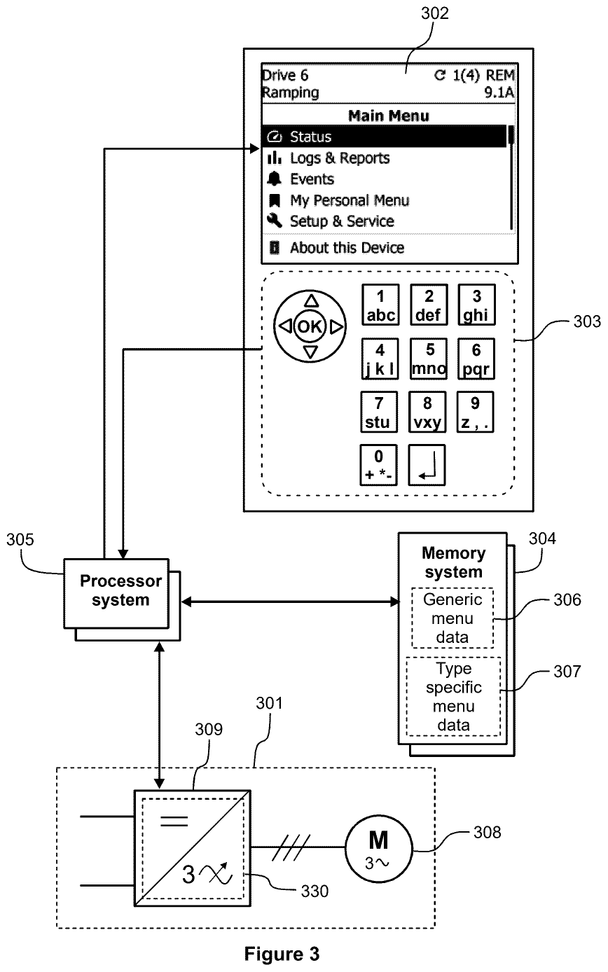

FIG. 3 illustrates a user interface according to an exemplifying and non-limiting embodiment for controlling an electric system 301. In the exemplifying case shown in FIG. 3, the electric system 301 is an AC motor drive comprising and AC electric motor 308 and a power electronic converter 309, in this case an inverter, for converting DC voltage to controllable three-phase AC voltage suitable for the AC electric motor 308, but, as mentioned earlier in this document, this is only one example. In this exemplifying case, the power electronic converter 309 comprises a power electronic main circuit 330 configured to convert the DC voltage to the controllable three-phase AC voltage, and control equipment configured to control the power electronic main circuit 330.

The user interface comprises a display 302 configured to present a menu structure to a user. The display 302 can be for example a liquid crystal display “LCD”. The display 302 can be a part of a user interface of the electric system 301, e.g. a part of a user interface of the power electronic converter 309, or the display 302 can be a part of an external device, e.g. a laptop or smartphone, communicatively connected to control and management means of the electric system 301.

The user interface comprises an input interface 303 configured to enable the user to navigate within the menu structure and to provide input data for the electric system 301. The input interface 303 can be a part of a user interface of the electric system 301, e.g. a part of the user interface of the power electronic converter 309, or the input interface 303 can be a part of an external device, e.g. a laptop or smartphone, communicatively connected to the control and management means of the electric system 301. In this exemplifying embodiment, the input interface 303 comprises a keyboard that has arrow and selection buttons for enabling the user to move in the menu structure and alphanumeric buttons for feeding an input data item, e.g. a current limit, speed limit, etc., when a menu item for feeding the input data item has been selected.

The user interface comprises a memory system 304 that stores first menu data 306, i.e. generic menu data, defining the above-mentioned menu structure. The memory system 304 may comprise one or more memory circuits which may comprise e.g. one or more electronically erasable programmable read-only memory “EEPROM” circuits or one or more other suitable memory circuits for storing data which must not be lost in power off situations. Furthermore, the memory system 304 may comprise one or more random-access memory “RAM” circuits for working memory. The memory system 304 can be a part of the electric system 301, e.g. a part of the power electronic converter 309, or the memory system 304 can be a part of an external device, e.g. a laptop or smartphone, communicatively connected to the control and management means of the electric system 301.

The user interface comprises a data processing system 305 communicatively connected to the display 302, to the input interface 303, and to the memory system 304. The data processing system 305 can be a part of the electric system 301, e.g. a central processing unit “CPU” or another processing unit of the power electronic converter 309, or the data processing system 305 can be a part of an external device, e.g. a laptop or smartphone, communicatively connected to the control and management means of the electric system 301. Typically, the user interface for managing the electric system 301 is a part of the electric system 301, but in FIG. 3 the user interface is depicted with separate functional elements for the sake of illustration.

The data processing system 305 is configured to control the display 302 to present the menu structure in accordance with the above-mentioned first menu data and with navigation input actions received from the input interface 303. The data processing system 305 is configured to submit input data received via the input interface 303 to the electric system 301. The input data may comprise for example configuration data, monitoring instructions, and/or troubleshooting instructions. The memory system 304 is configured to store second menu data 307, i.e. device or system type specific menu data, defining which of menu items defined by the first menu data 306 correspond to functionality of the electric system 301 under consideration. The data processing system 305 is configured to control the display 302 to present, as active and selectable menu items, only those of the menu items which correspond to the functionality of the electric system 301.

The menu structure defined by the first menu data 306 may comprise for example menu items such as “rotational speed”, “reactive power supplied to an AC grid”, “DC current”, etc. The above-mentioned second menu data 307 can be specific to a type of the electric system 301. In the exemplifying case shown in FIG. 3, where the electric device 301 comprises the power electronic converter 309 that is between the electric machine 308 and a DC supply, the menu item “reactive power supplied to an AC grid” does not correspond to the functionality of the electric system 301, whereas the menu items “rotational speed” and “DC current” correspond to the functionality of the electric system 301. Thus, the second menu data related to the electric system 301 expresses that the menu items “rotational speed” and “DC current” correspond to the functionality of the electric system 301 and that the menu item “reactive power supplied to an AC grid” does not correspond to the functionality of the electric system 301.

As the menu structure defined by the above-mentioned first menu data 306 can be a generic menu structure that can be used in conjunction with different electric devices and systems, the menu structures of these electric devices and systems can be similar with consistent appearances so that icons, menu items, and their naming can be similar across these electric devices and systems.

The implementation of the data processing system 305 can be based on one or more analogue circuits, one or more digital processing circuits, or a combination thereof. Each digital processing circuit can be a programmable processor circuit provided with appropriate software, a dedicated hardware processor such as for example an application specific integrated circuit “ASIC”, or a configurable hardware processor such as for example a field programmable gate array “FPGA”. Furthermore, the data processing system 305 may comprise working memory that can be implemented with one or more random-access memory “RAM” circuits.

The specific examples provided in the description given above should not be construed as limiting the scope and/or the applicability of the invention. Lists and groups of examples provided in the description given above are not exhaustive unless otherwise explicitly stated.

What is claimed is:

1. A method for implementing a user interface suitable for managing an electric device or system, the method comprising:
maintaining, in a memory system, first menu data defining a menu structure,
configuring a data processing system to control a display to present the menu structure defined by the first menu data to a user,
configuring an input interface to receive navigation input actions given by the user to navigate within the menu structure and to receive input data for the electric device or system, and
configuring the data processing system to submit the input data received from the input interface to the electric device or system,
wherein the method comprises:
maintaining, in the memory system, second menu data defining which of menu items defined by the first menu data correspond to functionality of the electric device or system, and
configuring data processing system to control the display to present, as active and selectable menu items, only those of the menu items which correspond to the functionality of the electric device or system.

2. The method according to claim 1, wherein the method comprises configuring the data processing system to control the display to show each menu item which does not correspond to the functionality of the electric device with a different graphical outlook than the active and selectable menu items.

3. The method according to claim 1, wherein the method comprises configuring the data processing system to control the display to present the menu structure without each menu item which does not correspond to the functionality of the electric device.

4. The method according to claim 1, wherein the input interface comprises a keyboard having arrow and selection buttons for enabling the user to move in the menu structure and alphanumeric buttons for enabling the user to feed an item of the input data when an input field for feeding the item of the input data has been activated.

5. The method according to claim 1, wherein the display comprises a touch screen acting as the input interface, and the method comprises configuring the data processing system to control the display to present virtual arrow and selection buttons enabling the user to move in the menu structure and virtual alphanumeric buttons enabling the user to feed an item of the input data when an input field for feeding the item of the input data has been activated.

6. The method according to claim 1, wherein the menu structure comprises a hierarchy of menus defined by the first menu data.

7. The method according to claim 1, wherein the menu items comprise one or more of the following i-iv: i) statuses of one or more elements of the electric device or system, ii) logs and reports related to the one or more elements, iii) events related to the one or more elements, and iv) set up and service data related to the one or more elements.

8. The method according to claim 1, wherein the electric device or system is a frequency converter.

9. A computer program for implementing a user interface suitable for managing an electric device or system, the computer program comprising computer executable instructions for controlling a programmable data processing system to:
retrieve, from a memory system, first menu data defining a menu structure,
control a display to present the menu structure defined by the first menu data to a user,
receive, from an input interface, navigation input actions given by the user to navigate within the menu structure and input data for the electric device, and
submit the input data received from the input interface to the electric device or system,
wherein the computer program comprises computer executable instructions for controlling the programmable data processing system to:
retrieve, from the memory system, second menu data defining which of menu items
defined by the first menu data correspond to functionality of the electric device or system, and
control the display to present, as active and selectable menu items, only those of the menu items which correspond to the functionality of the electric device or system.

10. A non-volatile computer readable medium encoded with a computer program according to claim 9.

11. A user interface for managing an electric device or system, the user interface comprising:
a display configured to present a menu structure to a user,
an input interface configured to enable the user to navigate within the menu structure and to provide input data for the electric device or system,
a memory system storing first menu data defining the menu structure, and
a data processing system communicatively connected to the display, to the input interface, and to the memory system,
wherein the data processing system is configured to control the display to present the menu structure in accordance with the first menu data and with navigation input actions received from the input interface, and to submit the input data received from the input interface to the electric device or system, wherein the memory system is configured to store second menu data defining which of menu items defined by the first menu data correspond to functionality of the electric device or system, and the data processing system is configured control the display to present, as active and selectable menu items, only those of the menu items which correspond to the functionality of the electric device or system.

12. The user interface according to claim 11, wherein the data processing system is configured to control the display to show each menu item which does not correspond to the functionality of the electric device with a different graphical outlook than the active and selectable menu items.

13. The user interface according to claim 11, wherein the data processing system is configured to control the display to present the menu structure without each menu item which does not correspond to the functionality of the electric device.

14. The user interface according to claim 11, wherein the input interface comprises a keyboard having arrow and selection buttons for enabling the user to move in the menu structure and alphanumeric buttons enabling the user to feed an item of the input data when an input field for feeding the item of the input data has been activated.

15. The user interface according to claim 11, wherein the display comprises a touch screen acting as the input interface, and the data processing system is configured to control the display to present virtual arrow and selection buttons enabling the user to move in the menu structure and virtual alphanumeric buttons enabling the user to feed an item of the input data when an input field for feeding the item of the input data has been activated.

16. The user interface according to claim 11, wherein the menu structure comprises a hierarchy of menus defined by the first menu data.

17. The user interface according to claim 11, wherein the menu items comprise one or more of the following i-iv: i) statuses of one or more elements of the electric device or system, ii) logs and reports related to the one or more elements, iii) events related to the one or more elements, and iv) set up and service data related to the one or more elements.

18. A power electronic converter comprising:
a power electronic main circuit configured to convert one or more input voltages to one or more output voltages,
control equipment configured to control the power electronic main circuit, and
a user interface according to claim 11.

19. The power electronic converter according to claim 18, wherein the power electronic converter is a frequency converter.
